(19) United States
(12) Patent Application Publication
(10) Pub. No.: US 2025/0067583 A1
(43) Pub. Date: Feb. 27, 2025

(54) DEVICE FOR FLUID MEASURING

(71) Applicant: PIETRO FIORENTINI S.p.A., Arcugnano (VI) (IT)

(72) Inventors: Mario VIANELLO, Rosate (MI) (IT); Lorenzo MEMÈ, Rosate (MI) (IT); Matteo D'ANGELO, Rosate (MI) (IT); Sergio GUZZETTI, Rosate (MI) (IT); Claudio IMBOCCIOLI, Creazzo (VI) (IT)

(73) Assignee: PIETRO FIORENTINI S.p.A., Arcugnano (VI) (IT)

(21) Appl. No.: 18/726,866

(22) PCT Filed: Feb. 17, 2023
(86) PCT No.: PCT/IB2023/051458

§ 371 Date: Jul. 5, 2024

(30) Foreign Application Priority Data
Feb. 18, 2022 (IT) 102022000003077

(51) Int. Cl. G01F 1/66; G01F 15/14

(52) U.S. Cl. CPC G01F 1/662; G01F 15/14

(57) ABSTRACT

A duct for the passage of a fluid to be detected/measured, for an ultrasound device includes: first and second pieces configured to be joined and fixed together to define a measurement channel, to be crossed by the fluid to be measured; a first port for the inlet/outlet of the fluid to be measured in/from the duct; and a second port for the outlet or entry of the fluid from/into the duct. The first piece includes a tubular portion with an open/missing area and the second piece is configured to close the first piece that the two pieces define the measurement channel which is closed in a fluid-tight manner in correspondence with the areas of union between the two pieces. The second piece includes an internal area configured to be lapped by the fluid passing through the duct and in which a signal emitted by a sensor is reflected.

### CROSS-REFERENCE TO RELATED APPLICATIONS

This application is a Section 371 National Phase of International Patent Application Number PCT/IB2023/051458, filed Feb. 17, 2023, which claims priority to Italian Patent Application Number 102022000003077, filed Feb. 18, 2022, the entire contents of all of which are incorporated by reference herein as if fully set forth.

### FIELD OF THE INVENTION

The present invention relates to a duct for the passage of a fluid to be measured, said duct being suitable for being used for/in an ultrasound device for measuring a fluid, preferably a gas.

The present invention also relates to an ultrasound device for measuring a fluid, preferably a gas, which is provided with said duct.

In particular, the device is of the type suitable for measuring one or more quantities relating to a fluid which passes through the passage duct with which the device is provided, and more specifically, it is suitable for measuring at least the flow rate and/or flow of fluid which passes through this duct. Preferably, said fluid is a gas and, in particular, it is natural gas or other gases produced in a decentralized way, such as biomethane or hydrogen.

Preferably, said device is suitable for use inside a gas meter and, in particular, a gas meter (also called “gas meter”).

Therefore, the invention finds advantageous use in the technical sector of the production and marketing of apparatus and devices for measuring fluids and can be advantageously used both at the domestic level and at the industrial level. Conveniently, the device according to the invention can be used for counting gas consumption in a domestic or industrial plant, or for counting gas consumption in general, for example when leaving a container.

### BACKGROUND

Various ultrasonic devices are currently known which can be installed inside a gas meter (also called “gas meter”) in order to measure the gas flow through the device itself.

Ultrasound devices of the known type, such as for example the one described and illustrated in JP2014215060, comprise a duct, with a substantially tubular development and a substantially rectangular cross section, for the passage of the gas to be measured. Furthermore, the duct of these devices has, in correspondence with the upper wall, an elongated insertion port (i.e. an open/missing portion) for the assembly and positioning inside the duct itself of a plurality of dividing plates which are made in a piece separate from the duct and which are configured and arranged in such a way as to make uniform the distribution of the flow velocity of the fluid passing through the duct. Once the partition plates have been inserted, the elongated insertion port is first covered with an entrainment flux suppression foil and then closed with a mounting block in which corresponding mounting seats are machined for a pair of ultrasonic sensors.

In particular, the two ultrasonic sensors, which are configured to emit and receive ultrasonic signals, are mounted at the top wall and are positioned one upstream and one downstream along the direction in which the fluid passes through the duct. In more detail, the ultrasonic signal emitted by a sensor is reflected from the internal surface of the wall, which is opposite to both sensors, towards the other sensor (and/or vice versa), thus defining a “V”-shaped reflection path and thus allowing the ultrasonic signal to intercept the flow of fluid flowing inside the duct.

In order to reduce the number of components which are made separately by molding, and therefore in order to reduce the corresponding costs, in particular of assembly, a solution has therefore already been proposed, such as the one illustrated in WO 2020/031621, WO 2020/031622 or WO 2020/044887, in which the duct for the passage of the fluid to be measured is molded in one piece with the dividing plates and furthermore, in correspondence with the upper wall of the duct, no elongated insertion ports are obtained, but are obtained two separate openings, each facing one of the two ultrasonic sensors, to thus allow the ultrasonic signals from the sensors to enter and exit said duct.

The known solutions do not allow the reflection of the ultrasonic signals emitted by a sensor and received by the other sensor to be varied and optimized in a simple way, in particular in terms of focusing.

EP2278281, EP3611480, EP3677877 and US2019/072421 relate to solutions in which the duct for the passage of the fluid to be measured is defined by two pieces (i.e. two halves) each of which has a cross section which defines a substantially concave profile (of the crescent type), and therefore open, for the entire longitudinal development of the piece itself; in particular, the two pieces respectively define the lower concave semi-piece (which is also provided at the ends with supports for the reflectors) and the upper concave semi-piece, both of which are concave along their entire length and which, only as a whole and therefore only following their mutual union, do they define a tubular portion. In other words, the two pieces essentially have the typical shape of two semi-tubes and, only following their union, do they define a tubular portion.

US2020/386591 relates to a solution in which the duct is defined by a tubular shaped piece which, in correspondence with the internal surface of the lower bottom wall, is provided with a depressed seat which is closed (and not open towards the outside) for housing of a reflector element.

US2019/226892 relates to a solution in which the duct is defined by a tubular-shaped piece which, in correspondence with the internal surface of the lower bottom wall, can be provided with a missing area which is open towards the outside and which is closed by a reflector element configured and inserted in said missing area; moreover, once the reflector element has been positioned and inserted, the seal is obtained by using a further piece which thus defines a closure cap, which however is not touched by the fluid flowing through the duct.

### OBJECTS OF THE INVENTION

The object of the invention is to propose a fluid passage duct to be used for/in an ultrasound device for measuring said fluid, preferably a gas, which allows to overcome, at least in part, the drawbacks present in the known solutions.

Another object of the invention is to propose an ultrasound device for measuring a fluid, preferably a gas, which allows the drawbacks present in the solutions of the prior art mentioned above to be overcome, at least in part.

Another object of the invention is to propose a duct and a device which allow to optimize the reflection, particularly in terms of focusing and collimation, of the ultrasonic signals towards the receiving ultrasonic sensor.

Another object of the invention is to propose a duct and a device which allow to attenuate or eliminate the out-of-phase components of the ultrasonic signals, thus improving the signal-to-noise ratio.

Another object of the invention is to propose a duct and a device which are fluid-tight, preferably gas-tight.

Another object of the invention is to propose a duct and a device which can be produced and assembled in series in a rapid and efficient manner.

Another object of the invention is to propose a duct and a device which are structurally and functionally completely reliable.

Another object of the invention is to propose a duct and a device which are improvements and/or alternatives to the traditional ones.

Another object of the invention is to propose a duct and a device which can be manufactured simply, rapidly and at low cost.

Another object of the invention is to propose a duct and a device which present an alternative characterization, both in constructive and functional terms, with respect to the traditional ones.

### SUMMARY

All the purposes mentioned here, considered both individually and in any combination thereof, and others which will result from the following description are achieved, according to the invention, with a duct and with a device as defined below.

### BRIEF DESCRIPTION OF THE DRAWINGS

The present invention is hereinafter further clarified in some of its preferred embodiments shown for purely exemplifying and non-limiting purposes with reference to the attached table of drawings, in which:

FIG. 1 shows a perspective view of the duct according to the invention,

FIG. 2 shows a different perspective view of the duct of FIG. 1,

FIG. 3 shows a perspective view of the duct of FIG. 1 exploded in the two components/pieces that compose it,

FIG. 4 shows a side view of the duct of FIG. 1 exploded in the two components/pieces that compose it,

FIG. 5 shows a section of the assembled duct of FIG. 1 with the ultrasonic sensors also mounted according to a plane which develops along the X and Y directions and passes through the center of the duct,

FIG. 6 shows a section of the assembled duct of FIG. 1 according to the VI-VI plane of FIG. 5,

FIG. 7 shows an exploded perspective view of the duct of FIG. 1 partially dissected,

FIG. 8 shows a perspective view of the partially sectioned assembled duct,

FIG. 9 shows a perspective view of the first piece of the duct according to the invention,

FIG. 10 shows a perspective view of the second piece of the duct according to the invention,

FIG. 11 is a perspective view of the second piece of fig. partially dissected,

FIG. 12 is a perspective view of a first variant of the second partially sectioned piece,

FIG. 13A shows in perspective view a second variant of the second partially sectioned piece,

FIG. 13B shows the duct assembled with the second piece of FIG. 13A with the ultrasonic sensors also mounted, sectioned according to a plane which develops along the X and Y directions and passes through the center of the duct,

FIG. 13C shows a section of the assembled duct of FIG. 13B according to the XIII-XIII plan of FIG. 13B,

FIG. 14A shows in perspective view a third variant of the second partially sectioned piece,

FIG. 14B shows the duct assembled with the second piece of FIG. 14A with the ultrasonic sensors also mounted, sectioned according to a plane which develops along the X and Y directions and passes through the center of the duct,

FIG. 15A shows in perspective view a fourth variant of the second partially sectioned piece,

FIG. 15B shows the duct assembled with the second piece of FIG. 15A with the ultrasonic sensors also mounted, sectioned according to a plane which develops along the X and Y directions and passes through the center of the duct,

FIG. 16 is a perspective view of a detail of the second partially sectioned piece,

FIG. 17 is a perspective view of a detail of the duct according to the invention.

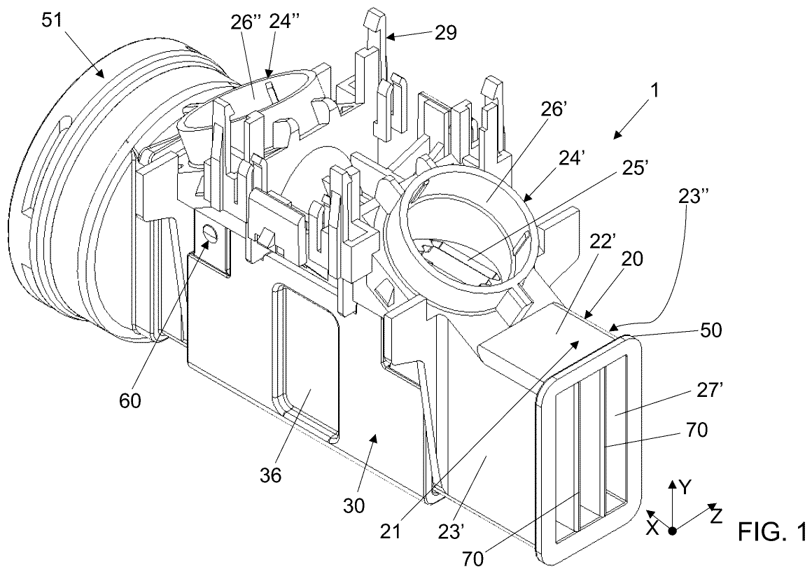

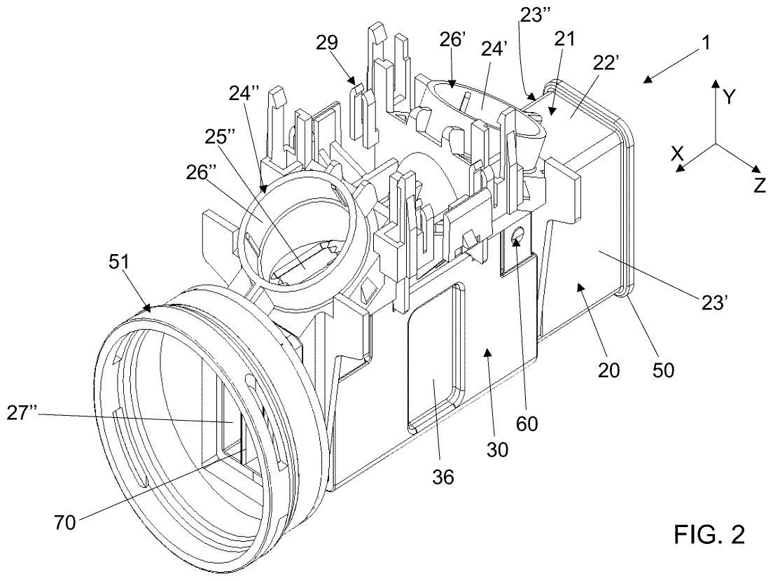

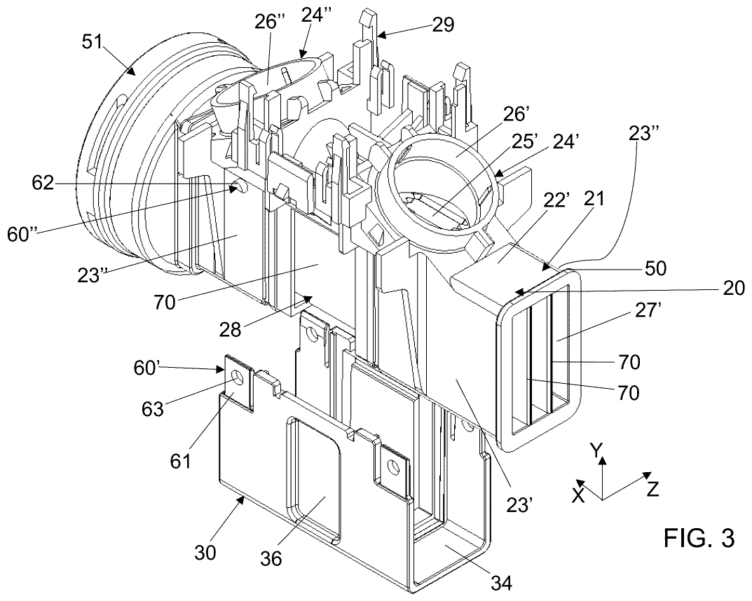

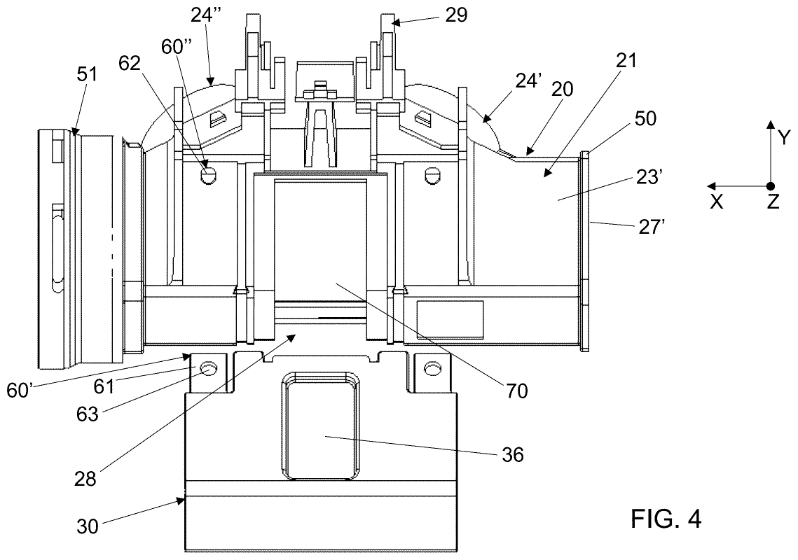

### DETAILED DESCRIPTION OF THE PREFERRED EMBODIMENTS

As can be seen from the figures, the present invention relates to a duct 1 for the passage of a fluid to be detected/measured, preferably a gas but could also be a liquid, for example water. In particular, the duct 1 is suitable to be used for/in an ultrasonic device for measuring the fluid. In particular, the device is of the type suitable for detecting the presence of a fluid and/or for measuring one or more quantities relating to the fluid flowing through the passage duct 1 with which the device is provided, and more specifically, it is suitable for measuring at least the flow rate and/or flow of fluid passing through said duct. Preferably, said fluid to be detected/measured is a gas and, in particular, it is natural gas or gas of other types produced in a decentralized way, such as biomethane or hydrogen.

Preferably, the device is suitable for use inside a gas meter and, in particular, a gas meter (also called “gas meter”).

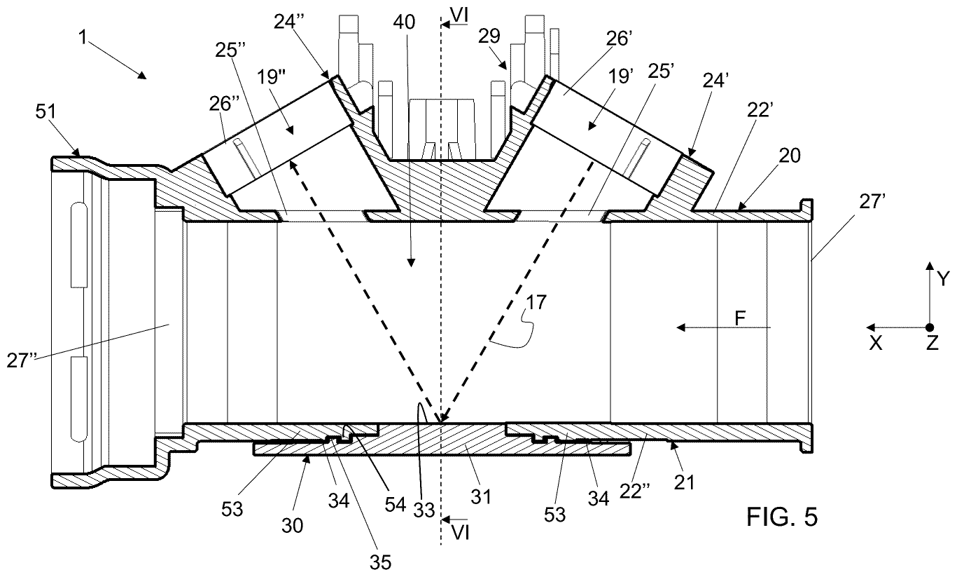

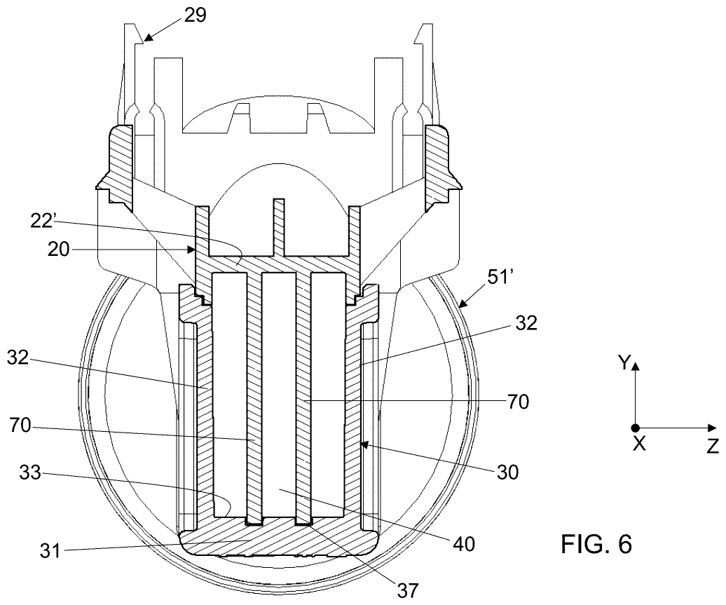

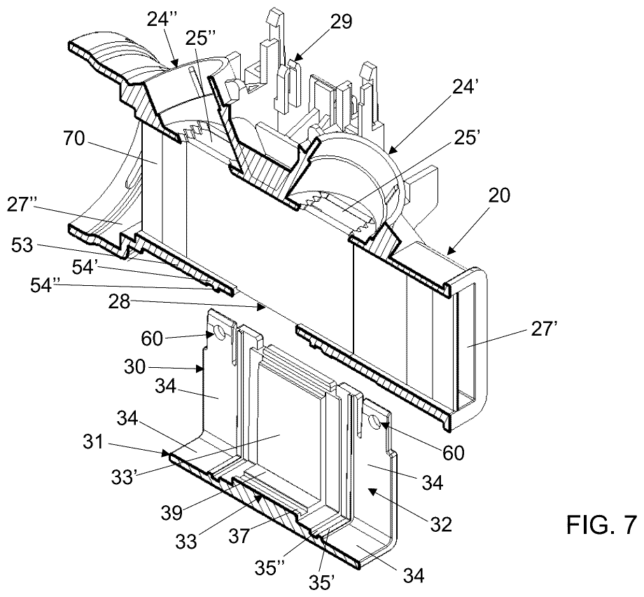

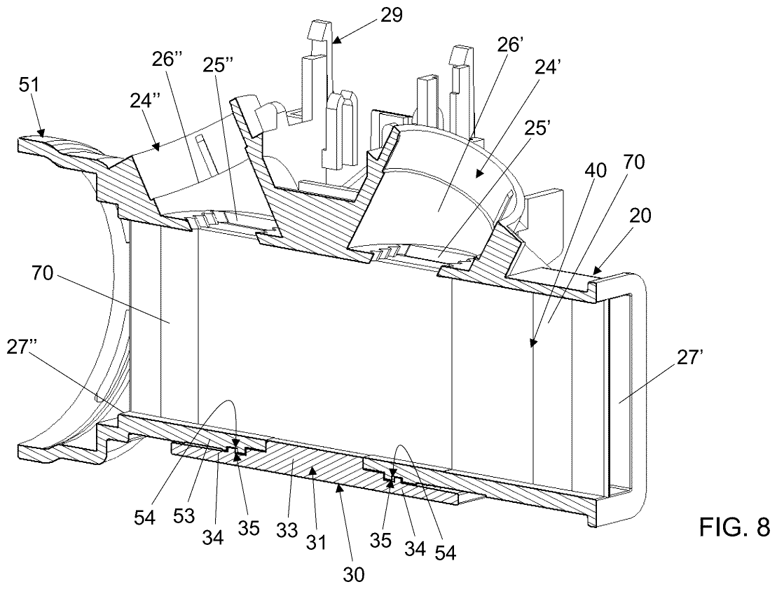

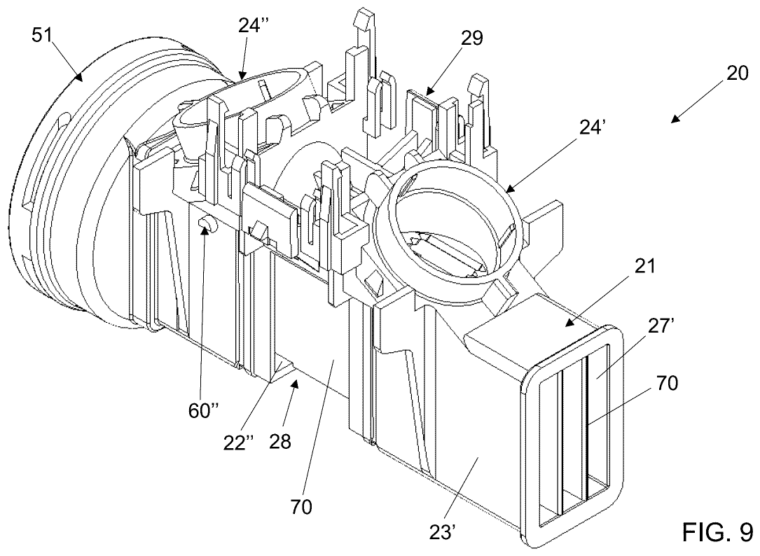

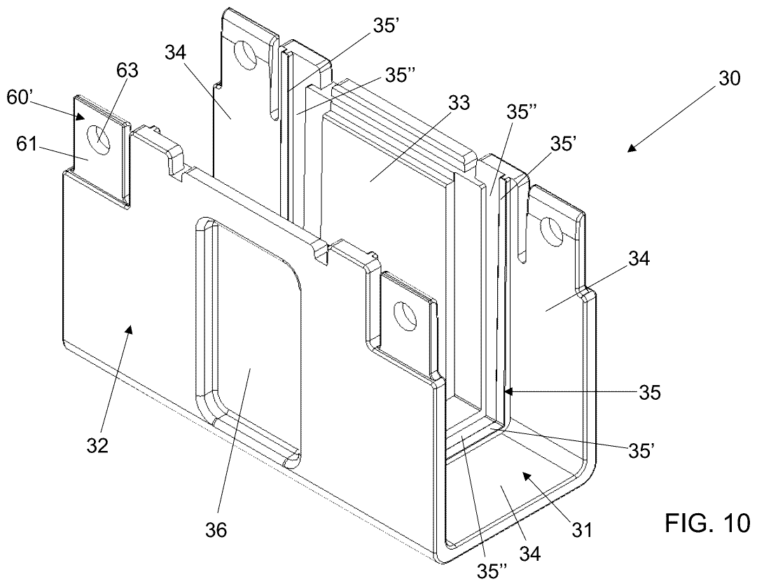

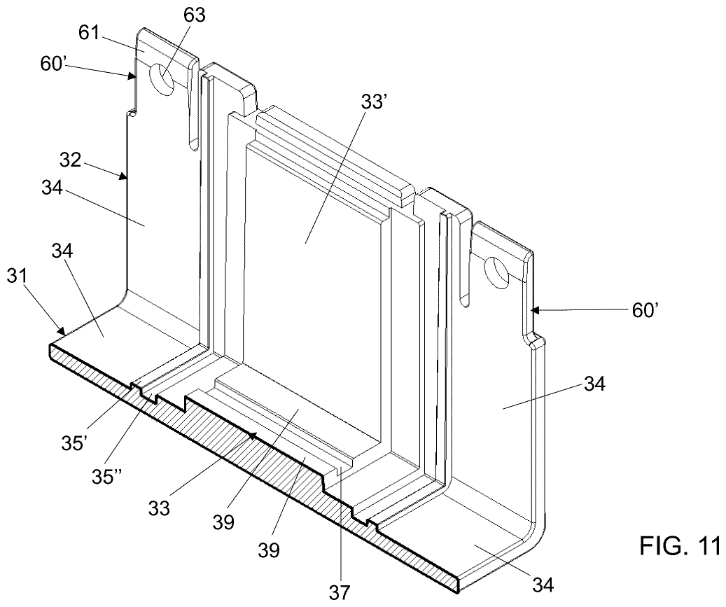

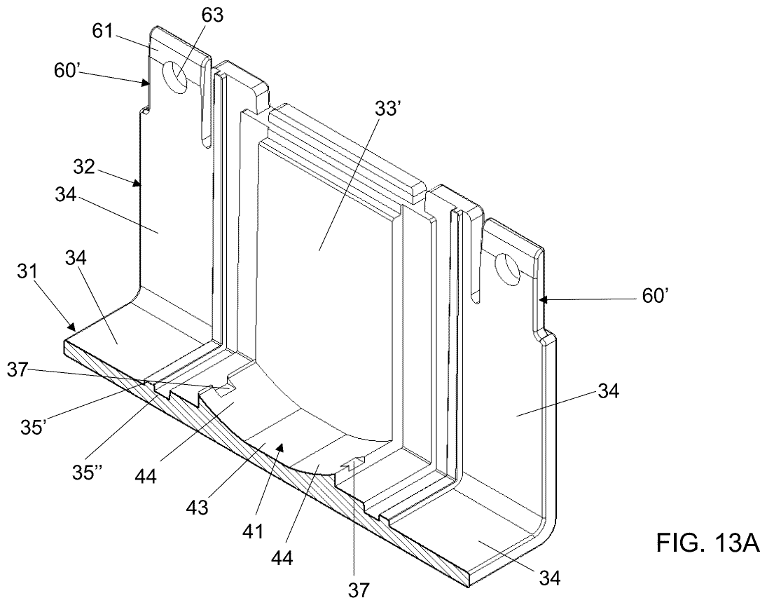

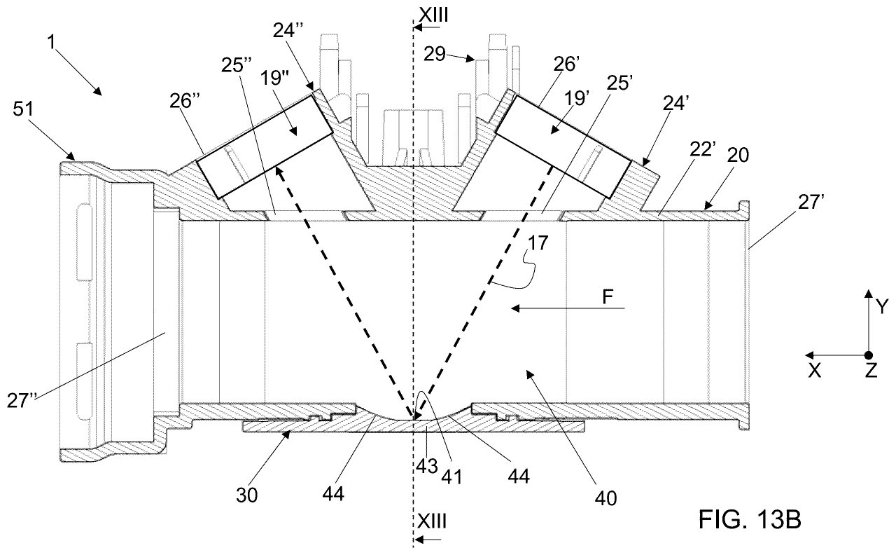

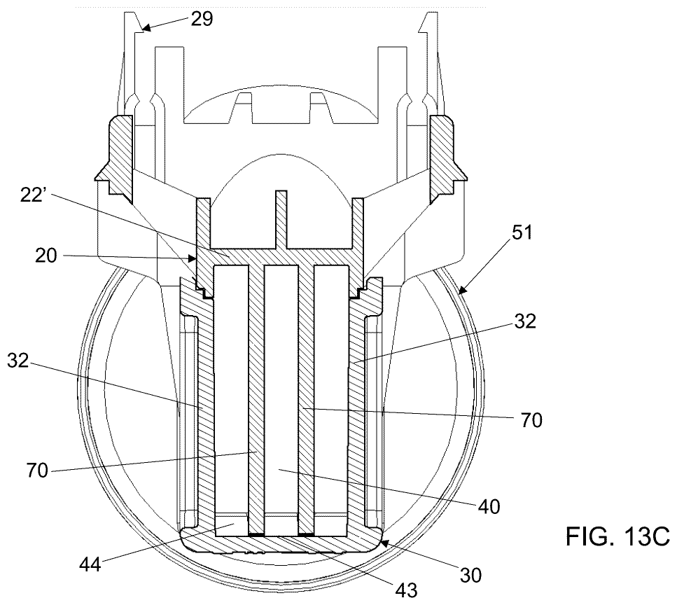

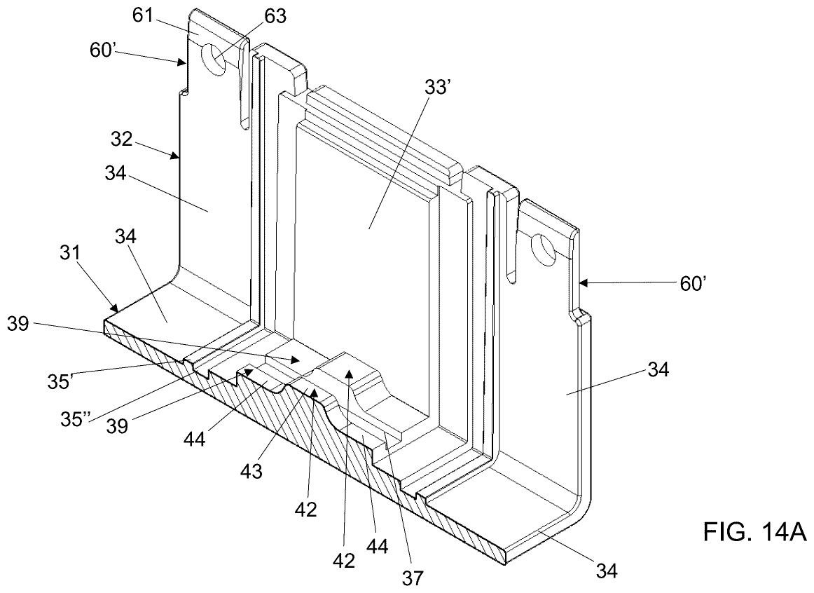

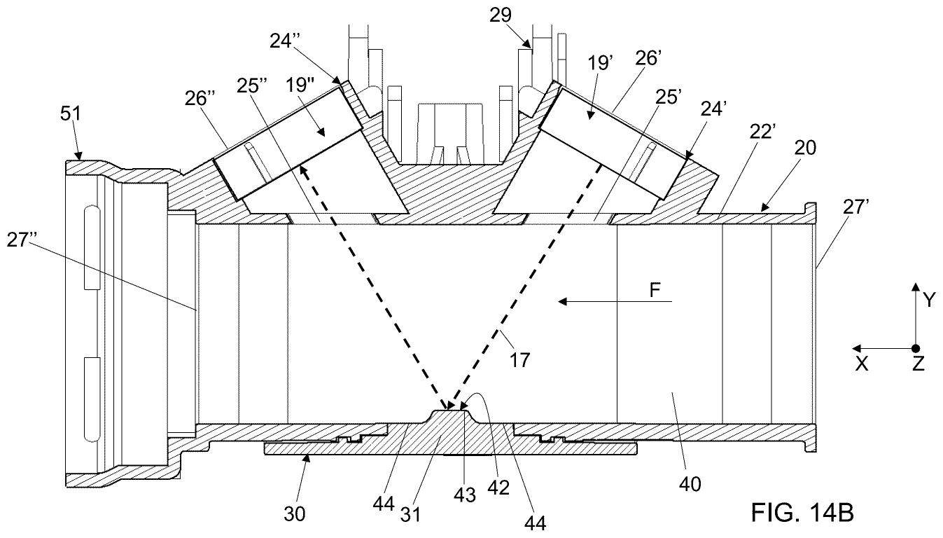

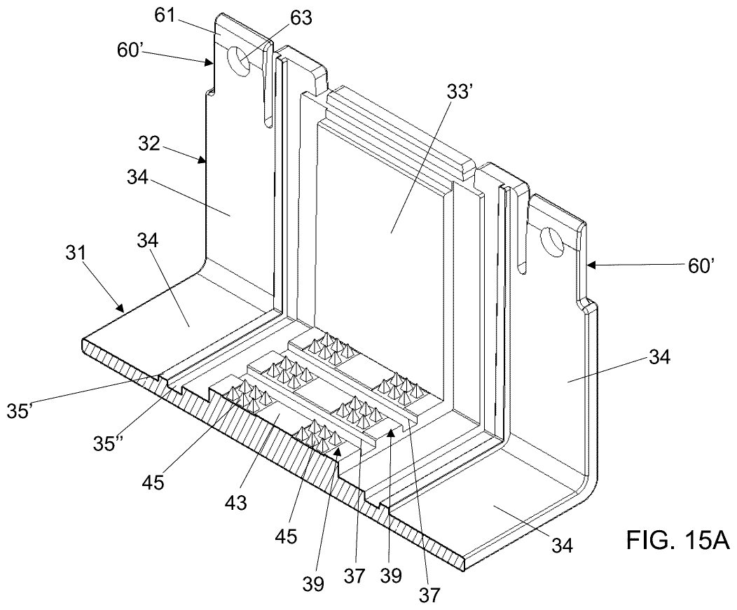

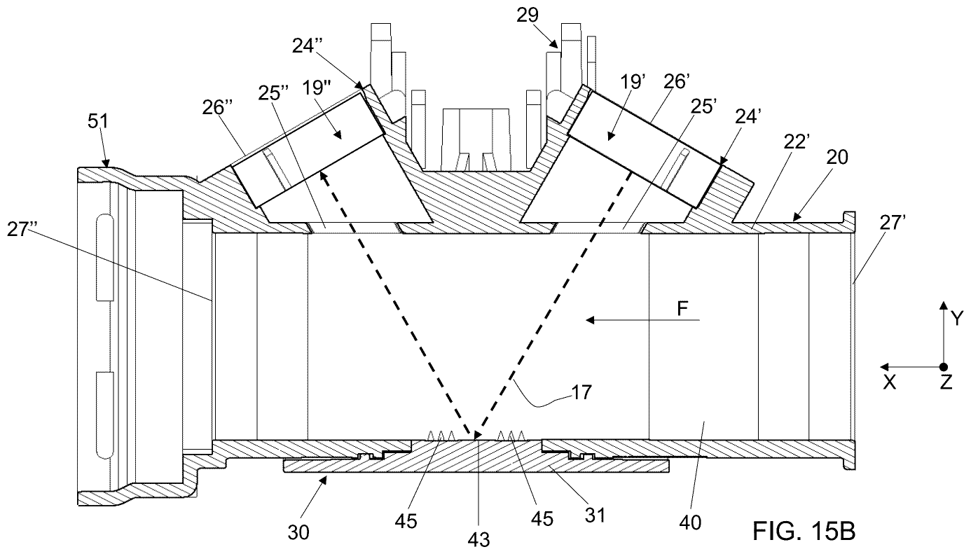

The duct 1 comprises two pieces, respectively a first piece 20 and a second piece 30, which are then fixed together to define, following their union and only in combination, a measurement channel 40 (cf. FIGS. 5, 8, 13B, 14B, 15B) which is intended to be crossed by the fluid to be measured. Conveniently, the measurement channel 40 is closed in a fluid-tight manner at least in correspondence with the areas of union/contact between the two pieces 20 and 30. Preferably, the measurement channel 40 is entirely closed in a fluid-tight manner along its longitudinal extension.

Preferably, the measurement channel 40—which is defined by the joining and fixing of the second piece 30 to the first piece 20—has a longitudinal development along the X direction, also corresponding to the main advancement direction of the fluid flow crossing the channel.

Preferably, the cross section of the measurement channel 40 is substantially rectangular and develops along a Y direction and along a Z direction, the Y and Z directions being perpendicular both to each other and to the X direction so as to thus complete the Cartesian triad, in where—preferably—the extent along the Y direction is greater than the extent along the Z direction.

Conveniently, the duct 1 comprises a first port 27′ for the inlet or outlet of the fluid to be measured in/from said duct 1 and a second port 27″ for the outlet or inlet of the fluid from/into said duct 1. The fluid to detect/measure can pass through the duct 1—and in particular the measurement channel 40—with a flow direction F which mainly goes from the first port 27′ towards the second port 27″. Conveniently, the first port 27′ and the second port 27″ are aligned and facing each other. Conveniently, it is understood that the fluid flow could cross the duct 1 in the opposite direction, ie be directed from the second port 27″ towards the first port 27′.

Conveniently, the two pieces 20 and 30—which, once they are fixed together, define the duct 1 and internally delimit the measurement channel 40—are made by molding. Conveniently, the two pieces 20 and 30 can be molded separately or together. Conveniently, the two pieces 20 and 30 can be molded by using a single suitable mold or with two distinct molds. Conveniently, the two pieces 20 and 30 can be extracted from the single mold already separated or they can be extracted still connected to each other (for example with a section of sprue), to be separated later.

The two pieces 20 and 30 are entirely or mostly made of polymeric material, preferably of thermoplastic material. The two pieces 20 and 30 are made by molding with at least one polymeric resin, for example PolyButylene Terephthalate (PBT), Glycoluryl-Formaldehyde (GF), PolyPropylene (PP), PolyOxyMethylene (POM), PolyCarbonate, Acrylonitrile ButadieneStyrene (ABS).

Preferably, the two pieces 20 and 30 are made of the same thermoplastic material. Conveniently, in a possible embodiment, the second piece 30 can be made of a different thermoplastic material than the first piece 20.

Preferably, the first piece 20 is made exclusively of thermoplastic material. Preferably, the second piece 30 can be made exclusively of a thermoplastic material or it can be made mainly of a thermoplastic polymeric material and also comprise inserts (as described in greater detail below) in a different polymeric material, thermoplastic or not, for example metallic. Preferably, the second piece 30 can comprise portions with a different or particular surface finish, for example treated so as to make it substantially “mirror-like”, to thus facilitate the reflection of the ultrasonic waves.

Conveniently, to define the measurement channel 40, the two pieces 20 and 30 are fixed and kept together by one or more technologies for joining plastic materials, such as in particular: gluing and/or welding (for example by laser, for ultrasound, hot blade, rotational friction) and/or hot plastic riveting and/or by mechanical joining (for example with shape/interlocking and/or hooking and/or snap-fit and/or press-fit engagement).

The first piece 20 comprises a tubular portion 21 which, preferably, extends along the longitudinal direction X.

Conveniently, the tubular portion 21 has a cross section defined by a profile with a closed shape.

Preferably, the tubular portion 21 has a substantially rectangular cross section, optionally with rounded corners. Preferably, the tubular portion 21 is not circular.

Preferably, the tubular portion 21 comprises:
a first wall 22′,
a second wall 22″ which faces the first wall 22′,
two side walls, and in particular a third wall 23′ and a fourth wall 23″, arranged between the first wall 22′ and the second wall 22″ so as to define a substantially rectangular cross-section.

Conveniently, the walls 22′, 22″, 23′ and 23″ of the tubular portion 21 of the first piece 20 are connected to each other so that said portion has a closed cross section.

Suitably, the two side walls 23′ and 23″ face each other along the Z direction, while the first wall 22′ and the second wall 22″ face each other along the Y direction. Suitably, the two side walls 23′ and 23″ extend between the first wall 22′ and the second wall 22″ substantially along the direction Y which is perpendicular to the longitudinal direction X. Conveniently, the first wall 22′ and the second wall 22″ extend each between the side walls 23′ and 23″ substantially along the Z direction.

Conveniently, the first piece 20 also comprises the first port 27′ and the second port 27″ of the duct 1.

Preferably, the first piece 20 also comprises one or more dividing plates 70 which are made in a single body with the first piece 20 and which are positioned inside the tubular portion 21 so as to divide the inside of the channel into two or more layers measurement channel 40 obtained by joining and fixing the first piece 20 with the second piece 30. Preferably, said at least one dividing plate 70 can be molded in a single body with the tubular portion 21 of the first piece 20.

Preferably, each dividing plate 70 has a substantially laminar development in which the extension along the Z direction (thickness) is much smaller than the extension along the other two directions X and Y. Conveniently, each dividing plate 70 can be arranged at the inside of the tubular portion 21 so as to lie on a plane which extends along the two directions X and Y.

Conveniently, if several dividing plates 70 are provided, these plates can be arranged so as to be spaced apart from each other and substantially parallel to each other along the Z direction.

Preferably, each dividing plate 70 can have a variable thickness along the X direction and, in particular, can have a maximum thickness in correspondence with a central portion interposed between the first port 27′ and the second port 27″, and also having a thickness gradually decreasing towards the first port 27′ and towards the second port 27″.

Preferably, the leading and/or trailing edges of each partition plate 70 can be curved, i.e. chamfered and rounded.

Preferably, the first port 27′ comprises a flanged edge 50. Preferably, in correspondence with the first port 27′, the flanged edge 50 can join up with the tubular portion 21 with a curved profile with outward concavity, thus defining a portion funnel (not shown). Preferably, the dividing plates 70 extend along the X direction until they arrive substantially flush with the first port 27′.

Conveniently, the first piece 20 can also comprise means 51 for connecting the piece itself (and therefore of the duct 1 resulting from the union of the union of the two pieces) with other components of the measuring device inside which the duct 1—and the corresponding device provided with the duct—is intended to be installed. Preferably, these connection means 51 are provided at the second port 27″ and can comprise, for example, a connection/hooking area provided with elements (for example slots) for the mechanical engagement of corresponding counter-elements of a component (not shown) housed inside the measuring device in which a device provided with duct 1 is also installed.

Conveniently, at the first wall 22″, the first piece 20 comprises at least two openings, 25′ and 25″ respectively, for the passage of ultrasonic signals 17 emitted and received by a pair of ultrasonic sensors 19′, 19″ which are positioned side by side, one upstream and one downstream along the direction X in which the fluid F crosses the duct.

Preferably, the two openings 25′ and 25″ are obtained on the first wall 22″ of the tubular portion 21 of the first piece 20 and are configured so that the ultrasonic signals (waves) 17, emitted by at least one corresponding ultrasonic sensor 19′, 19″, enter and/or leave the measurement channel 40—which is obtained by joining and fixing the second piece 30 to the first piece 20—crossing said openings.

Conveniently, at the first wall 22″, the duct 1 can comprise corresponding mounting portions 24′ and 24″ for a pair of ultrasonic sensors 19′, 19″. Conveniently, each mounting portion 24′ and 24″ comprises a corresponding seat, respectively 26′ and 26″, configured to receive a corresponding ultrasonic sensor 19′, 19″. Each seat 26′ and 26″ communicates with a respective opening 25′ and 25″ so that the ultrasonic signals 17 can enter and exit the measurement channel 40.

Conveniently, each mounting portion 24′ and 24″—and in particular the respective seat 26′ and 26″—can be configured so that the ultrasonic signals 17 emitted by the sensors 19′, 19″ enter and exit the/from the measurement channel 40 at an angle with respect to the X direction, and in particular with respect to the main direction of advance of the fluid flow F inside the channel.

Conveniently, at the first wall 22″, the duct 1 can also comprise means 29 for mounting an electronic board provided with a command and control unit (for example microprocessor or microcontroller) for the ultrasonic sensors 19′, 19″ and/or a processing unit (for example microprocessor or microcontroller) of what is detected by the ultrasonic sensors 19′, 19″.

Preferably, in a possible embodiment such as the one shown here, the mounting portions 24′ and 24″ are made (molded) in one piece with the first piece 21, however—in a possible embodiment not shown here-said portions could be made/molded in one or more separate pieces with respect to the first piece 21 and then be fixed to the latter by gluing or welding or by mechanical fixing.

The first piece 20 comprises an open/missing area 28 at the area where the ultrasonic signal 17 emitted by one of the two sensors 19′, 19″, preferably by both sensors 19′, 19″, would be reflected (if said area 28 was not open/missing) towards the other sensor or towards a further reflection area provided on the internal surface of the first wall 22′.

Preferably, in a possible embodiment in which the reflection path is substantially “V” shaped, said open/missing area 28 is positioned at the vertex of the angle defined between two ideal straight lines which cross the two sensors 19′, 19″, and in particular defined between the straight lines normal to the two sensors 19′, 19″,

Preferably, in a possible embodiment in which the reflection path is substantially V-shaped, said open/missing area 28 is positioned at the meeting point of the signal 17 emitted by the two sensors 19′, 19″,

Preferably, in a possible embodiment in which the reflection path is substantially V-shaped, said open/missing area 28 is positioned at the meeting point of the normal directions of the two openings 25′, 25″.

Conveniently, when the duct 1 is assembled, i.e. when the first piece 20 and the second piece 30 are joined and fixed, the reflection of the signal 17 emitted by one of the two sensors 19′, 19′ takes place in correspondence with the open/missing area 28′, and preferably from both sensors 19′, 19″, towards the other sensor 19″, 19′, or towards a further reflection area (not shown) provided on the internal surface of the first wall 22″.

Conveniently, this open/missing area 28 of the first piece 20 is obtained (at least) on a part of the second wall 22″ of the tubular portion 21 of the first piece 20.

Preferably, the tubular portion 21 of the first piece 20 is configured in such a way that the second wall 22″ is missing/open—for at least one part of it—in correspondence with the area facing the area of the first wall 22′ interposed between the two openings 25′ and 25″ (and in particular between the upstream edge of the upstream opening 25′ and the downstream edge of the downstream opening 25″) for leakage of the ultrasonic signals 17 inside the measurement channel 40 resulting from the union and fixing of the two pieces 20 and 30.

Preferably, the open/missing area 28 which affects the second wall 22″ of the first piece 20 is configured to also affect at least a part of the side walls 23′ and 23″ which join with the corresponding second wall 22″ in correspondence of the open/missing area 28.

Preferably, the open/missing area 28 can affect most or substantially the entirety of the development along the Y direction of the corresponding area of the side walls 23′ and 23″ which joins up with the open/missing area 28 which affects the second wall 22″.

The second piece 30 is configured so as to close the first piece 20 in correspondence with the open/missing area 28 so that, the two pieces thus joined and fixed, define the measurement channel 40 which is closed fluid-tight at least in correspondence of the union/contact areas between the two pieces, thus preventing the fluid passing through the first piece 20 from escaping in correspondence with the open/missing area 28 and/or in correspondence with the areas where the two pieces 20 and 30 are in contact with each other.

Conveniently, the second piece 30 comprises, in correspondence with its surface facing the inside of the measurement channel 40, an internal area 33 which is intended to be lapped by the fluid which passes through the duct 1 and in which said ultrasonic signal 17, emitted by at least one sensor, preferably by a pair of sensors 19′, 19″, is reflected. In particular, the internal area 33 of the second piece 30—which is the same piece which seals the open/missing area 28 obtained on the first piece 20—is lapped by the fluid and also reflects the ultrasonic signal 17 emitted by at least one sensor, preferably by a pair of sensors 19′, 19″.

Basically, the reflection points for the ultrasonic signals 17 are defined on the internal surface of the second piece 30 which is touched by the fluid which passes through the duct 1.

Advantageously, the second piece 30 has, at least in part, a substantially complementary shape suitable for closing the open/missing area 28 obtained on the first piece 20.

Conveniently, the second piece 30 comprises a closing wall 31 which is configured so as to close the open/missing area 28 which is obtained on the second wall 22″ of the first piece 20. Preferably, once the second piece 30 is joined and fixed to the first piece 20, the closing wall 31 is substantially coplanar or in any case parallel to the second wall 22″. Preferably, the closing wall 31 extends substantially along the X and Z directions.

Preferably, the second piece 30 also comprises one or more closing side walls 32 which are configured so as to close the open/missing area 28 which affects one or both side walls 23′ and 23″ of the first piece 20. Preferably, the closing wall 31 extends substantially along the X and Y directions.

Preferably, the closing wall 31 is configured to be fixed to the first piece 20 so as to be substantially coplanar or in any case parallel to the second wall 22″. Preferably, once the second piece 30 is joined and fixed to the first piece 20, the closing side walls 32 are substantially coplanar or in any case parallel to the third 23′ or fourth wall 23″ respectively.

Preferably, the second piece 30 comprises a closing wall 31 and two closing side walls 32, facing each other along the Z direction, which develop perpendicularly from the respective lateral edges (edges which develop along the X direction and which are parallel and opposite) of the closing wall 31. Preferably, the second piece 30 comprises a closing wall 31 and also two closing side walls 32 arranged so as to define as a whole a transversal section (on the YZ plane) substantially U-shaped.

Conveniently, the union of the two pieces 20 and 30 is carried out first by positioning them reciprocally so that the closing wall 31 of the second piece 30 is substantially facing the open/missing area 28 obtained in the second wall 22″ of the first piece 20, and then by a movement of one piece with respect to the other (preferably of the second piece 30 towards the first piece 20) substantially along the Y direction so as to bring the closing wall 31 and the first wall 22′ closer to each other.

Conveniently, the closing wall 31 of the second piece 30 comprises, at its internal surface (i.e. the surface which, when the two pieces are joined, is intended to face the inside of the resulting measurement channel 40), an internal area 33 which is intended to face directly (that is, without the interposition of other walls or other pieces) towards the inside of the measurement channel 40 to thus be directly lapped by the fluid which passes through the channel itself. Basically, the surface of the internal area 33 of the second piece 30 internally delimits the measurement channel 40 in correspondence with the missing/open area 28 of the first piece 20.

Conveniently, the first piece 20 and the second piece 30 are configured in such a way that, when they are joined and/or fixed together, the edges of the internal area 33 of the second piece 20 are substantially flush with the parts 53 which surround the open/missing area 28 of the first piece.

Preferably, the internal area 33 comprises an upstream edge and a downstream edge—which develop at an angle with respect to the X direction and, preferably, develop along the Z direction—which, when the two pieces 20 and 30 are joined and/or fixed together to thus define the measurement channel 40, go flush with the internal surface of the parts 53 of the second wall 22″ which surround the open/missing area 28 obtained in the second wall itself, to thus define a substantially continuous which avoids the formation of turbulence in the fluid flow.

Conveniently, also the closing side walls 32—if provided—comprise a further internal area 33′ which is intended to be lapped by the fluid flowing through the duct but without receiving said ultrasonic signal 17 emitted by at least one sensor, preferably by a pair of sensors 19′, 19″. In particular, said further internal area 33′ of the closing side walls 32 is lapped by the fluid which passes through the channel 40 but without receiving (in particular directly) any said ultrasonic signal 17 emitted by the ultrasonic sensors 19′, 19″.

Conveniently, as mentioned, in correspondence with the internal area 33 of the closing wall 31 of the second piece 30, the ultrasonic signals 17 emitted by the sensor 19′, 19″ are reflected towards the other sensor 19″, 19′, thus defining a substantially “V”-shaped reflection path of the ultrasonic signals 17, or—in an embodiment not shown—towards a possible further reflection area obtained or defined in correspondence with the first wall 22′, to thus define a reflection path substantially to “W” of the ultrasonic signals 17.

Conveniently, the closing wall 31 of the second piece 30 comprises, in correspondence with its internal surface (i.e. the surface which, when the two pieces are joined, is intended to face the inside of the resulting measurement channel 40), at least an external area 34 which is configured to come into contact with the external surface of the parts 53 of the second wall 22″ which surround the open/missing area 28 obtained in the second wall itself. Preferably, the external areas 34 are positioned around the internal area 33, and particularly upstream and/or downstream of the latter with respect to the development of the closing wall along the X direction.

Advantageously, also the closing side walls 32—if provided—comprise at least a corresponding external area 34, as described above for the closing wall 31, which is configured to come into contact and abut with the external surface of the parts 53 which they surround the open/missing area 28 obtained in the third 23′ or fourth wall 23″.

Conveniently, each outer area 34 can comprise, in correspondence with its internal surface, shaped portions 35 (for example protruding portions 35′ and/or depressed portions 35″) which are configured to engage in shape relationship in respective counter-shaped sections 54 (for example further depressed sections 54″ complementary to the protruding portions 35′ and/or further protruding sections 54′ complementary to the depressed portions 35″) which are obtained in the parts 53 which surround the open/missing area 28 of the first piece 20.

Advantageously, the shaped portions 35 can be provided both on the closing wall 31 and on the closing side walls 32. Conveniently, in a corresponding way, the counter-shaped sections 54 can be provided on the parts 53 which surround the open/missing area 28 both of the second wall 22′ and of the side walls 23′ and 23″.

Preferably, the shaped portions 35 involve the closing wall 31 for the whole or in any case for most of its development along the Z direction. Conveniently, in a corresponding way, the counter-shaped sections 54 involve the parts 53 which surround the open/missing area 28 of the second wall 22′ for the whole or in any case for most of their development along the Z direction.

Preferably, the shaped portions 35 involve the closing side walls 32 for the whole or in any case for most of their development along the Y direction. Conveniently, in a corresponding way, the counter-shaped sections 54 involve the parts 53 which surround the open/missing area 28 of the lateral walls for the whole or in any case for most of their development along the Y direction.

Conveniently, the shaped portions 35 of the closing side walls 32 of the second piece 30 are configured to engage by sliding within the corresponding counter-shaped sections 54 of the side walls 23′ and 23″ of the first piece 20.

Preferably, the shaped portions 35 affect both the closing wall 31 and both the closing side walls 32 in a continuous way—i.e. without interruptions, not even in correspondence with their junction section. Suitably, in a corresponding way, the counter-shaped sections 54 affect in a continuous way—i.e. without interruptions, not even in correspondence with their joining section—the parts 53 which surround the open/missing area 28 both of the second wall 22′ and of the side walls 23′ and 23″.

Advantageously, the shaped portions 35, made on the closing side walls 32 of the second piece 30, and the respective counter-shaped section 54, made on the side walls 23′ and 23″ of the first piece 20, are configured in such a way that their reciprocal shape engagement allows or in any case contributes to locking the second piece 30 to the first piece 20 along the X direction.

Advantageously, the engagement between the shaped portions 35, made on the closing side walls 32 of the second piece 30, and the respective counter-shaped sections 54, made on the side walls 23′ and 23″ of the first piece 20, allow the correct insertion/positioning of the second piece 30 on the first piece 20, as well as—preferably—also serve as a guide during the movement along the Y direction of one piece with respect to the other during their joining.

Advantageously, two or more shaped portions 35 can be provided which are configured and which engage in a shape relationship in respective two or more counter-shaped sections 54 so as to define a particularly tortuous path (i.e. with numerous curved or elbow sections) and this in order to avoid—or in any case make it particularly difficult—the escape of gas from the channel 40 towards the outside in correspondence with the areas of union between the two pieces.

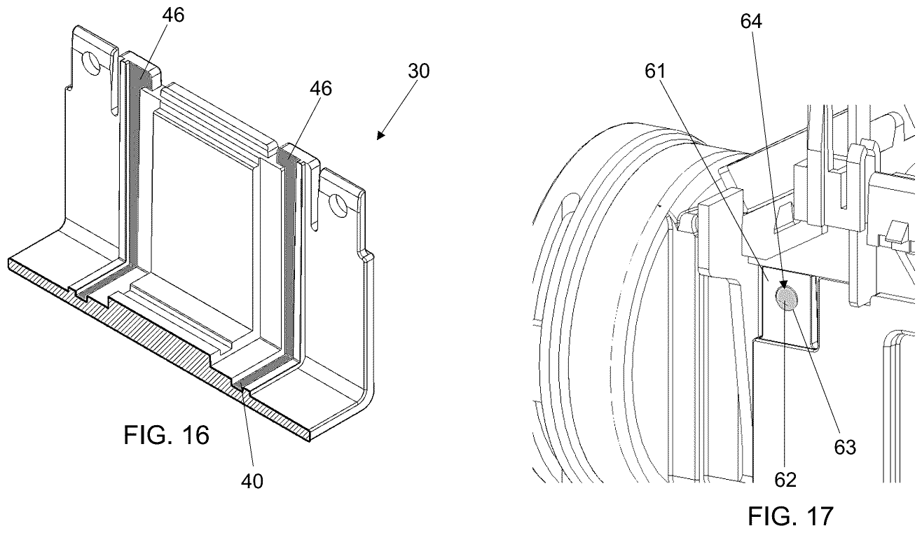

Preferably, in a possible embodiment (see FIG. 16), a suitable adhesive 46 can be applied in the shaped portions 35 of the second piece 30 to also allow an engagement by gluing between the shaped portions 35 of the second piece 30 and the counter-shaped sections 54 of the first piece 20.

Advantageously, the second piece 30 comprises corresponding depressed areas 36 which are formed on the outer surface of the closing side walls 32 to facilitate gripping of the second piece 30 during the step of joining the two pieces, in particular by respectively positioning the thumb on the depressed area of one wall 32 and the index finger on the depressed area of the other wall 32.

Preferably, the closing wall 31 and/or the closing side walls 32 of the second piece 30 have a thickness of about 0.8-2.5 mm, more preferably for example about 1.5 mm.

Advantageously, the first piece 20 and the second piece 30 comprise mechanical engagement means 60, preferably mechanical engagement means for hooking (for example clip), for press-fit, for interlocking and/or snap (also called “snap-fit”). Preferably, the mechanical engagement means 60 comprise first means 60′ provided on the closing side walls 32 of the second piece 30 and which are configured to engage by hooking, interlocking and/or snap with second means 60″ provided on the side walls 23′ and 23″ of the first piece 20.

Preferably, in a possible embodiment, the first means 60′ comprise at least one tab 61 which is resiliently yielding and which has a hole 63 into which a corresponding pin 62 which defines the second means 60″ engages by interlocking. Suitably, each tab 61 has a suitable elastic yield so that the contact of its end, preferably blunt, with the pin 62 causes its bending until the pin itself faces the hole 63, thus allowing the elastic return of the tongue and the interlocking insertion of the pin inside the hole. Advantageously, moreover, the pin 62 can be further fixed in the hole 63 of the tab 61 by means of welding 64 (see FIG. 17), preferably by ultrasound.

Preferably, two tabs 61 are provided which develop perpendicularly from each free edge, which develops along the X direction, of each closing side wall 32, while two corresponding pins protrude perpendicularly from the surrounding parts 53, close to the first wall 22′, the open/missing area 28 of each side wall 23′ or 23″.

Conveniently, the mechanical engagement means 60 are configured to be activated when the joint movement between the second piece 30 and the first piece 20 reaches corresponding end-of-stroke positions. Conveniently, the mechanical engagement means allow the two pieces 20 and 30 to be fixed and kept stably joined together over time.

Advantageously, the two pieces 20 and 30 are configured in such a way that first the shaped portions 35, formed on the closing side walls 32 of the second piece 30, engage by sliding within the respective counter-shaped sections 54 formed on the side walls 23′ and 23″ until reaching an end-of-stroke position (identified by a corresponding abutment condition) in which the mechanical engagement means 60 are substantially (or can be) also activated, so as to thus keep the two pieces 20 and 30 firmly united and fixed to each other.

Conveniently, as mentioned, the reflection of the ultrasonic signals 17 emitted by an ultrasonic sensor 19′, 19″ occurs at the internal surface of the internal area 33 of the closing wall 31 of the second piece 30.

Preferably, the internal area 33 comprises at least one groove 37, which extends longitudinally along the direction X, configured to receive inside it by means of shape coupling the end part 38, which faces the open/missing area 28, of a corresponding dividing plate 70.

Preferably, each groove 37 and each end part 38 of the partition plate 70 which fits into a corresponding groove 37 are configured so as to define an engagement and interlocking of such a shape as to substantially prevent the entry of fluid inside the groove.

Preferably, the internal area 33 of the second piece 30 can comprise one or more areas 39, at which the ultrasonic signals 17 are intended to be reflected, which are made of a different material than the remaining part of the second piece 30 and/or to the first piece 20. Conveniently, said at least one reflection area 39 is defined on the second piece 30 and, therefore, it is defined on the same piece that closes the first piece 20 in correspondence with the open/missing area 28 in a fluid-tight manner, the reflection area 39—i.e. the area which receives the ultrasonic signals 17 emitted by the sensors or already reflected—is obtained on the second piece 30 or in any case is defined by an insert which is integrated or associated in a non-removable way with said second piece 30. Preferably, said insert can be associated in a non-removable way with the second piece 30 from the moment of molding of said second piece 20 or in any case before joining/fixing the if second piece 30 to the first piece 20 (in this case the insert is first associated with the second piece 30 and then it is the assembly thus obtained which is joined/fixed to the first piece 20).

Conveniently, said at least one reflection area 39 does not face the sensors 19′ and 19″, but is displaced and interposed between the two sensors 19′ and 19″ along the X direction of longitudinal development of the channel 40.

Advantageously, the internal area 33 of the second piece 30 comprises one or more areas 39, in correspondence with which the ultrasonic signals 17 are intended to be reflected, with a different surface finish with respect to the remaining part of the second piece 30 and/or with respect to the first piece 20.

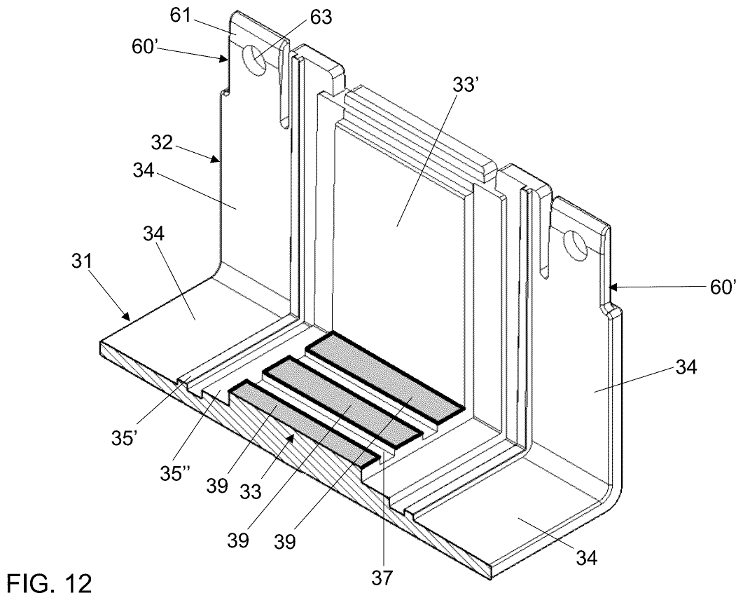

Preferably the areas 39 are made or treated so as to define a glossy surface (cf. FIG. 12).

Advantageously, the internal area 33 of the second piece 30 comprises one or more areas 39, in correspondence with which the ultrasonic signals 17 are intended to be reflected, with a different conformation with respect to the remaining part of the second piece 30 and/or with respect to the first piece 20. Preferably, the areas 39 may comprise a recessed profile 41 and/or a protruding profile 42. Preferably, the recessed profile 41 and/or the protruding profile 42 comprises suitably chamfered sections and is free from sharp edges.

Advantageously, the areas 39 can comprise a reflection section 43, preferably with a substantially flat development, configured to direct the incident ultrasonic signal 17 towards the receiving sensor 19″, 19′, and two further sections 44, located respectively upstream and downstream (along the X direction) with respect to the reflection stretch, configured to reflect the incident ultrasonic signals 17 so that they do not reach the receiving sensor 19″, 19′, thus avoiding disturbances by ultrasonic signals 17 (out of phase) which fall outside the reflection section 43

Preferably, said two further sections 44 can have a substantially concave profile or can comprise diffraction gratings 45, for example defined by a plurality of equal pyramids, equidistant and aligned with each other along the X and Z directions.

Conveniently, each area 39 can comprise at least one section to optimize the reflection of the ultrasonic rays emitted by an ultrasonic sensor 19′, 19″. Advantageously, each area 39 is defined between two adjacent grooves 37.

Conveniently, in a possible embodiment, in correspondence with the areas of the second piece 30 which come into mutual contact with the first piece 20 when these are joined together, gaskets can be provided, preferably made of rubber or other soft material. Conveniently, in this case, the rubber seals are co-molded with the body of the second piece 30 which is made of plastic.

The present invention also relates to an ultrasound device for measuring a fluid, preferably for measuring the flow rate of a gas, which is provided with a duct 1 as described above.

The device also comprises a pair of ultrasonic sensors 19′, 19″ which are respectively arranged one upstream and one downstream along the longitudinal development direction X of the measurement channel 40 which is defined once the two pieces 20 and 30 of the duct 1 are joined and fixed together. Conveniently, the ultrasonic sensors 19′, 19″ are operatively associated with the duct 1 so as to emit ultrasonic signals 17 within the measurement channel 40 and receive the ultrasonic signals 17 emitted and reflected within said channel.

Conveniently, each ultrasonic sensor can be of the traditional type in itself and is configured to emit and/or receive ultrasonic signals 17.

Preferably, the two ultrasonic sensors 19′, 19″ are mounted respectively in the mounting portions 24′ and 24″ of the first piece 20 of the duct 1.

Preferably, the two ultrasonic sensors 19′, 19″ are mounted so that the ultrasonic signals 17 are emitted and received diagonally with respect to the longitudinal development direction X of the measurement channel 40 and diagonally with respect to the main advancement direction of the fluid at the inside of this channel.

The device also comprises a unit for measuring the flow rate and/or flow of the fluid which passes through the channel 40 of the duct 1 of the device itself. In particular, the measurement unit is configured to calculate the flow rate on the basis of the propagation time of the ultrasonic signals 17 between the two sensors 19′, 19″, in particular from the upstream sensor 19′ to the downstream one 19″, and/or vice versa. In particular, the propagation time is the period of time which elapses between the instant in which a sensor 19′, 19″ emits an ultrasonic signal 17 so as to make it propagate through the fluid to be measured up to the instant in which said ultrasonic signal 17 is received by the other sensor 19″, 19′. Conveniently, the configuration of the flow rate or flow measurement unit is obtained, in a manner per se known to those skilled in the art and therefore not described in detail below, on the basis of the propagation time.

Conveniently, said flow rate measurement unit comprises a microprocessor or microcontroller mounted on an electronic card which is electronically connected to the pair of ultrasonic sensors 19′, 19″.

Conveniently, the ultrasonic signals 17 emitted by a sensor 19′ or 19″ are reflected in correspondence with the areas 39 of the internal area 40 of the second piece 20 towards the other sensor 19″ or 19′, to thus define a reflection path substantially “V” shaped of the ultrasonic signals 17, or—in an embodiment not shown—towards a possible further reflection area obtained or defined in correspondence with the first wall 22′ of the first piece, to thus define a reflection path substantially to “W” of the ultrasonic signals 17.

Conveniently, it is understood that the duct 1 can have any shape, not necessarily and exclusively with a straight tubular development as shown in the figures, thus generically meaning any structure, of any shape and size, which is crossed by a fluid which enters at a first port and exits at a second port, or vice versa. Conveniently, for example, the duct 1 can comprise, upstream and/or downstream of the measurement channel, a portion shaped like a tank or a chamber, variously shaped, as well as a further tubular section. Conveniently, the duct 1 can consist only of the two pieces 20 and 30 (as shown in the figures), but could also comprise further pieces (not shown here). Conveniently, the first piece 20 can consist only of the tubular portion 21 (as illustrated in the figures), but could also comprise—in addition to the tubular portion 21—further variously shaped portions (not shown here).

Preferably, at least one further sensor can be mounted or integrated on the second piece 30 for measuring a quantity of the fluid which passes through the measurement channel 40; for example, said further sensor can be a humidity sensor, a temperature sensor, a sensor which detects the presence/concentration of CO₂ and/or in general another sensor configured to measure a quantity of the fluid which passes through the measurement channel 40 Advantageously, this allows the second piece to be suitably selected according to the quantities to be detected, and this can be done without modifying the first piece to be installed or already installed and/or the electronics (which would thus remain the same), allowing thus economies of scale and reuse of already tested electronics.

From what has been said it is clear that the duct and the device according to the invention are particularly advantageous because:
has a high modularity, in particular allowing to easily vary and optimize the reflection characteristics of the ultrasonic signals that are emitted inside the duct,
the second piece—which is made/molded separately from the first piece—closes the first piece in correspondence with the open/missing area of the latter so as to define a sealed measurement channel at least in correspondence with the union/contact areas between the two pieces and, in addition, also defines the reflection surface for the ultrasonic signals emitted by the sensors,
the second piece—which is made/molded separately from the first piece—can be made, at least in correspondence with the reflection surface, of a suitable and dedicated shape, material and/or surface finish, and this in order to improve the focusing of the ultrasonic signals (creating for example a lens effect) towards the receiving sensor, thus compensating the sensor tolerance, and/or in order to attenuate or eliminate non-collimated ultrasonic signals (i.e. those out of phase or incident in an area too upstream or too downstream), thus improving the signal-to-noise ratio,
it can be made and assembled in a simple, rapid and low-cost way,
is structurally and functionally entirely reliable, and
it is an improvement and/or alternative to traditional solutions.

The present invention has been illustrated and described in a preferred embodiment thereof, but it is understood that executive variants can be applied to it in practice, without however departing from the scope of protection of the present patent for industrial invention.

1. Duct, for the passage of a fluid to be detected and/or measured, said duct configured to be used for/in an ultrasound device for measuring the fluid, the duct comprising:
a first piece and a second piece, which are entirely or mostly made of polymeric material by molding, and which, once molded, are configured to be joined and fixed together to define, following their union, a measurement channel, which is configured to be crossed by the fluid to be measured,
a first port for the inlet or outlet of the fluid to be measured in/from said duct,
a second port for the outlet or entry of the fluid from/into said duct, wherein:
the first piece comprises a tubular portion with an open/missing area,
said second piece is configured so as to close the first piece in correspondence with the open/missing area so that the two pieces thus united and fixed, define said measurement channel which is closed in a fluid-tight manner in correspondence with the areas of union between the two pieces, said second piece comprising in correspondence with its surface facing the inside of the measurement channel an internal area which is intended to be lapped by the fluid passing through the duct and in which an ultrasonic signal emitted by at least one sensor is reflected, or by a pair of sensors, configured to be operatively associated with said duct so as to emit said ultrasonic signal inside the measurement channel.

2. The duct according to claim 1, wherein the tubular portion of the first piece comprises:
a first wall at which said sensors are configured to be mounted,
a second wall which faces the first wall,
two side walls and a fourth wall arranged between the first wall and the second wall so as to define a substantially rectangular cross-section.

3. The duct according to claim 2, wherein:
said open/missing area is obtained, at least in part, on said second wall,
said second piece comprises a closing wall which is configured to close said open/missing area which is obtained, at least in part, on said second wall, said closing wall comprising, in correspondence with its surface facing the inside of the measurement channel, said internal area which is intended to be lapped by the fluid which passes through the duct and in which said signal is reflected ultrasonic signal emitted by at least one or by a pair of sensors.

4. The duct according to claim 2, wherein:
said open/missing area is also obtained on at least one of said side walls, or on both said side walls,
said second piece comprises at least one closing side wall which is configured to close said open/missing area which is obtained, at least in part, on at least one of said side walls,

5. The duct according to claim 4, wherein at least one closing side wall comprises, in correspondence with its surface facing towards the inside of the measurement channel, a further internal area which is configured to be lapped by the fluid passing through the duct but without receiving said ultrasonic signal emitted by said at least one sensor, or by said pair of sensors.

6. The duct according to claim 1, wherein said first piece and said second piece are configured such that, when they are joined and/or fixed together, edges of the internal area of the second piece are substantially flush with the parts surrounding the open/missing area of the first piece.

7. The duct according to claim 1, wherein said second piece comprises at least one external area which is configured to come into contact with an external surface of the parts which surround the open/missing area obtained in the first piece.

8. The duct according to claim 7, wherein each outer area of the second piece comprises, in correspondence with its internal surface, shaped portions which are configured to engage in shape relationship in respective portions counter-shaped which are obtained in the parts which surround the open/missing area of the first piece.

9. The duct according to claim 1, wherein said first piece and the second piece comprise mechanical engagement means for hooking, for press-fit, for interlocking, snap and/or snap-fit.

10. The duct according to claim 1, wherein the internal area of the second piece comprises at least one area, in correspondence with which the ultrasonic signals are configured to reflect, which is made of a different material and/or with a different surface finish with respect to the remaining part of the second piece and/or with respect to the first piece.

11. The duct according to claim 1, wherein the internal area of the second piece comprises at least one area, in correspondence with which the ultrasonic signals are configured to reflect which comprise a recessed profile and/or a protruding profile.

12. The duct according to claim 1, wherein the internal area of the second piece comprises at least one area comprising a reflection section, configured to direct the ultrasonic signal incident towards the receiving sensor, and two further sections, placed respectively upstream and downstream of the reflection section, configured to reflect the incident ultrasonic signals such that the incident ultrasonic signals do not reach the receiving sensor.

13. The duct according to claim 1, further comprising, in correspondence with the first wall, corresponding mounting portions for a pair of ultrasonic sensors, each mounting portion comprising a corresponding seat configured to receive a corresponding ultrasonic sensor 19′, 19″.

14. The duct according to claim 1, wherein each assembly portion is configured so that the ultrasonic signals emitted by the sensors enter and exit into/from the measurement channel at an angle to the direction of longitudinal development of the measurement channel.

15. The duct according to claim 1, wherein at least one further sensor is mounted or integrated on the second piece for measuring a quantity of the fluid flowing through the measurement channel.

16. Ultrasonic device, for measuring a fluid, comprising:
a duct according to claim 1,
at least two ultrasonic sensors which are operatively associated with said duct so that each sensor emits ultrasonic signals inside the measurement channel defined within said duct and receives the ultrasonic signals emitted by the other sensor and reflected within said channel,
a unit for measuring the flow rate and/or flow of the fluid which passes through the channel of the duct, said measuring unit being configured to calculate the flow rate on the basis of the propagation time of the ultrasonic signals between the two sensors.
